(19) United States
(12) Patent Application Publication
(10) Pub. No.: US 2015/0157528 A1
(43) Pub. Date: Jun. 11, 2015

(54) MASSAGE APPARATUS AND MASSAGE CHAIR WITH HEALTH MONITORING DEVICES

(71) Applicants: KEVIN LE, RICHLAND HILLS, TX (US); THANH LE, GRAND PRAIRIE, TX (US); MANTHAN SHETH, ARLINGTON, TX (US); BRYCE GASTON, DALLAS, TX (US)

(72) Inventors: KEVIN LE, RICHLAND HILLS, TX (US); THANH LE, GRAND PRAIRIE, TX (US); MANTHAN SHETH, ARLINGTON, TX (US); BRYCE GASTON, DALLAS, TX (US)

(73) Assignee: LURACO TECHNOLOGIES, INC., ARLINGTON, TX (US)

(21) Appl. No.: 14/454,712

(22) Filed: Aug. 7, 2014

Related U.S. Application Data
(63) Continuation of application No. 14/103,840, filed on Dec. 11, 2013.

(51) Int. Cl. A61H 15/00

(52) U.S. Cl. CPC A61H 15/0078; A61H 2201/0149; A61H 2015/0035

(57) ABSTRACT

The present invention is directed to a massage apparatus for a massage chair wherein massage benefits or effects are provided to a back body area, a seat or bottom body area, and a thigh body area of a user. Massage benefits or effects may also be provided to a head and neck body area of the user. The massage apparatus includes a frame and a massage device. Also, the present invention is directed to a massage chair that includes a massage apparatus and at least one health monitoring device or system. As a non-limiting example, the at least one health monitoring device or system is a portable, wrist blood pressure and heart rate monitoring device that is manufactured and/or programmed to measure or obtain blood pressure and heart rate of the user right at or near the massage chair when the user is preferably positioned on the massage chair.

### CROSS-REFERENCE TO RELATED APPLICATION

The present application claims the priority benefit of U.S. Nonprovisional patent application Ser. No. 14/103,840, filed Dec. 11, 2013, which is incorporated herein by reference in its entirety.

### BACKGROUND OF THE INVENTION

1. Field of the Invention

The present invention generally relates to massage chairs and massage devices and apparatuses for massage chairs. More specifically, the present invention is directed to a massage apparatus for a massage chair wherein massage benefits or effects are provided to a back body area, a bottom body area, and a thigh body area of a user. Massage benefits or effects may also be provided to a head and neck body area of the user. Also, the present invention is directed to a massage chair that includes a massage apparatus and at least one health monitoring device.

2. Description of the Related Art

Massage chairs and massage devices and apparatuses for massage chairs are known in the art.

Most or all of the patents, published patent applications, and/or non-patent publications directed at massage chairs and massage devices and apparatuses for massage chairs disclose massage benefits or effects being provided to a back body area of a user. At least one discloses massage benefits or effects being provided from the neck to the shoulder, back, and hips.

The present invention overcomes one or more of the shortcomings of massage chairs and massage devices and apparatuses for massage chairs. The Applicant is unaware of inventions or patents, taken either singly or in combination, which are seen to describe the present invention as claimed.

### SUMMARY OF THE INVENTION

The present invention is directed to a massage apparatus for a massage chair wherein massage benefits or effects are provided to a back body area, a seat or bottom body area, and a thigh body area of a user. Massage benefits or effects may also be provided to a head and neck body area of the user. The massage apparatus includes a frame and a massage device. Also, the present invention is directed to a massage chair that includes a massage apparatus and at least one health monitoring device.

As one aspect of the present invention and a non-limiting example, the frame of the massage apparatus includes a pair of opposing guide rails, a plurality of guide rails stabilizing bars, and a base stand. The guide rails are secured to the base stand, and are positioned generally above the base stand. The base stand supports the weights of the guide rails, massage device, and user of the massage chair.

Each of the guide rails includes a first end, a second end, a thigh body area portion located adjacent the first end, a seat or bottom body area portion located adjacent the thigh body area portion and away from the first end, a back body area portion extending upward from the bottom body area portion, a head and neck body area portion extending upward from the back body area portion and located about the second end, an outer side, an inner side, and a guide channel extending from the thigh body area portion to the back body area portion, preferably to the head and neck body area portion, and running along the inner side of the guide rail. The guide channel includes gear teeth for engaging with at least one gear member from the massage device when the massage device preferably moves upward and downward in a generally vertical direction from the first end toward the second end of the guide rail and vice versa, respectively. Preferably, each of the guide rails has a generally “L-shaped” configuration. In this configuration, the lower portion of the “L” includes the thigh body area portion and bottom body area portion, and the upper portion of the “L” includes the back body area portion and head and neck body area portion. More preferably, each of the guide rails has a reclining “L-shaped” configuration.

The plurality of guide rails stabilizing bars help to stabilize the positioning of the guide rails relative to one another. Each of the guide rails stabilizing bars has a first end, a second end, and a body portion extending from the first end to the second end. The guide rails stabilizing bars are secured at predetermined locations along the outer sides of the guide rails.

The base stand includes a base and a guide rails support structure. The base includes a first or front end, a second or rear end, and a pair of opposing sides. The guide rails support structure is secured about the front end of the base, and is positioned above the base. The guide rails support structure includes a plurality of vertical bars or members and a plurality of horizontal bars or members. The plurality of vertical bars extend upward from the pair of opposing sides of the base, and, along with the plurality of horizontal bars, form a support frame with a “square-shaped” or “rectangular-shaped” box configuration.

The massage device includes a power source, at least one massage element, and at least one gear member. The massage device may be a conventional massage device that is known to one of ordinary skill in the art.

As a non-limiting example, the massage device includes a pair of massage device moving members, a pair of gear members, a pair of massage arms, a first motor, a second motor, a third motor, a rotation shaft driven by the first motor, a pair of rotation to knocking translator members, a rotation shaft driven by the second motor, a pair of rotation to kneading translator members, a rotation shaft for vertical movement gears driving, a speed reduction belt for the first motor, and a speed reduction belt for the second motor.

Each of the pair of massage device moving members is positioned within a corresponding guide channel of a guide rail, and helps the massage device move in a generally vertical direction along the guide channel.

Each of the pair of gear members is positioned within a corresponding guide channel of a guide rail, and engages with the teeth located in the corresponding guide channel.

Each of the pair of massage arms includes a first or upper massage roller and a second or lower massage roller. Each of the pair of massage arms can move vertically. As a non-limiting example, each of the pair of massage arms may be able to move both vertically and laterally. The massage rollers provide massage benefits or effects to a back body area, a bottom body area, and a thigh body area of the user when the massage device is moved to or near that particular body area. The massage rollers may also provide massage benefits or effects to a head and neck area of the user when the massage device is moved to or near the head and neck area.

The first and second motors provide power to the pair of massage arms, respectively, while the third motor provides power for the generally vertical movement of the massage device.

The rotation shaft driven by the first motor causes the first massage arm to be activated and to carry out its massage actions when this rotation shaft is rotated.

Each of the pair of rotation to knocking translator members assists the corresponding massage arm and corresponding massage roller(s) to carry out its knocking massage actions when the corresponding rotation shaft is rotated.

The rotation shaft driven by the second motor causes the second massage arm to be activated and to carry out its massage actions when this rotation shaft is rotated.

Each of the pair of rotation to kneading translator members assists the corresponding massage arm and corresponding massage roller(s) to carry out its kneading massage actions when the corresponding rotation shaft is rotated.

The rotation shaft for vertical movement gears driving causes the massage device to move upward or downward when this rotation shaft is rotated.

The speed reduction belt for the first motor adjusts the speed of the first massage arm.

The speed reduction belt for the second motor adjusts the speed of the second massage arm.

As another aspect of the present invention, the massage chair includes a massage apparatus and at least one health monitoring device.

As a non-limiting example, the at least one health monitoring device is a portable, wrist blood pressure and heart rate monitoring device that is manufactured and/or programmed to measure or obtain the blood pressure and heart rate of the user right at or near the massage chair when the user is preferably positioned on the massage chair.

### BRIEF DESCRIPTION OF THE DRAWINGS

FIG. 1 is a perspective view of a massage apparatus for a massage chair according to the present invention;

FIG. 2 is a front view of the massage apparatus for a massage chair of FIG. 1;

FIG. 3 is a right side view of the massage apparatus for a massage chair of FIG. 1;

FIG. 4 is a perspective, front view of a massage device of the massage apparatus for a massage chair of FIG. 1;

FIG. 5 is a perspective, front and right side view of a massage device of the massage apparatus for a massage chair of FIG. 1;

FIG. 6 is a perspective, rear view of a massage device of the massage apparatus for a massage chair of FIG. 1;

FIG. 7 is a perspective, rear and right side view of a massage device of the massage apparatus for a massage chair of FIG. 1;

FIG. 8 is another perspective, rear and right side view of a massage device of the massage apparatus for a massage chair of FIG. 1; and

FIG. 9 is an environmental perspective, front and right side view of a massage chair according to the present invention, showing at least one health monitoring device or system being positioned on or secured to a user.

It should be understood that the above-attached figures are not intended to limit the scope of the present invention in any way.

### DETAILED DESCRIPTION OF THE PRESENT INVENTION

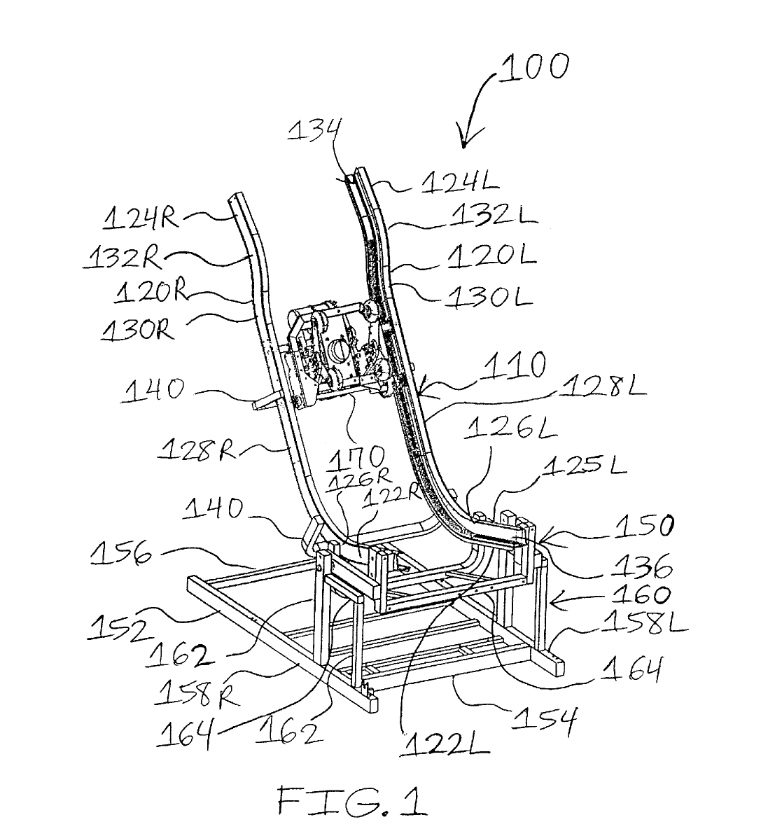

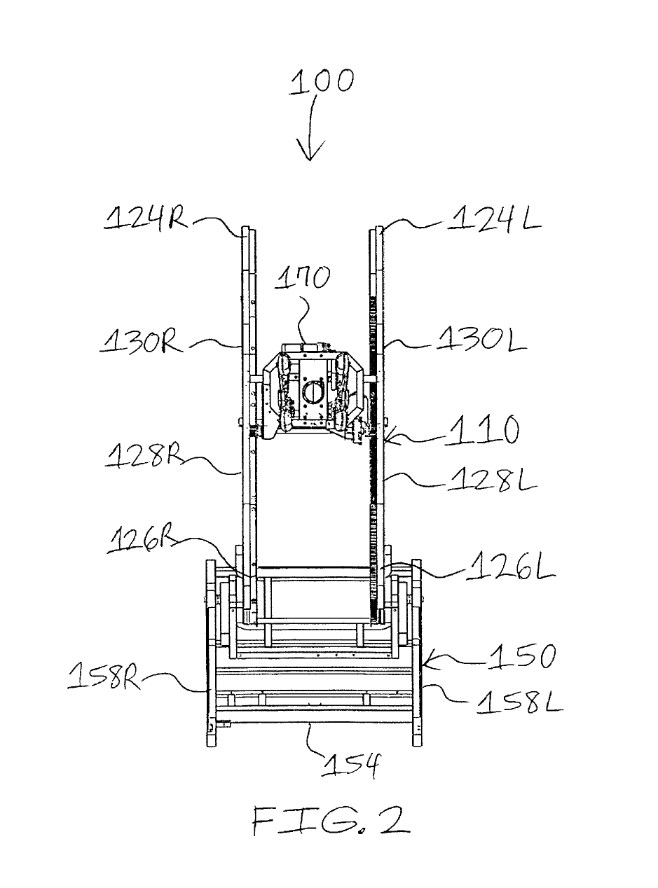

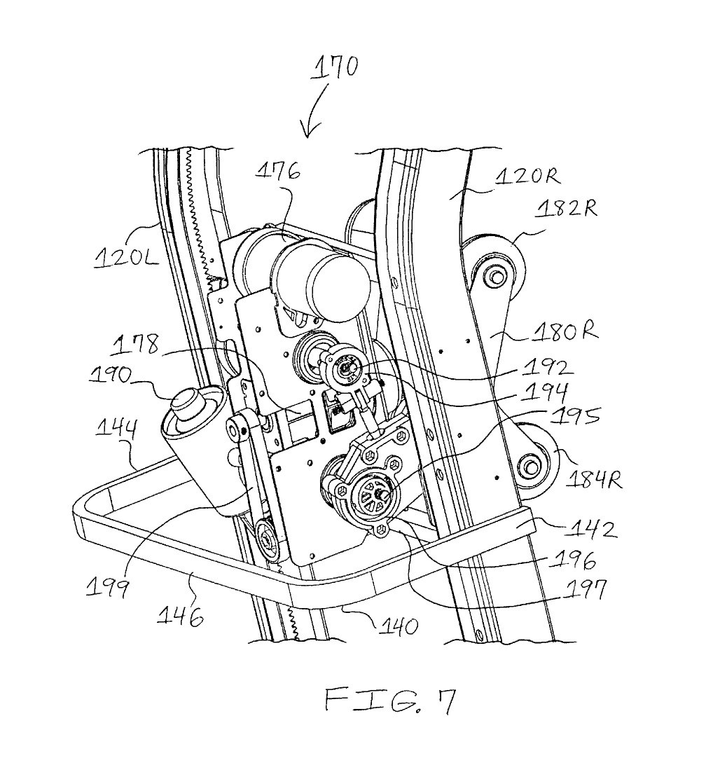

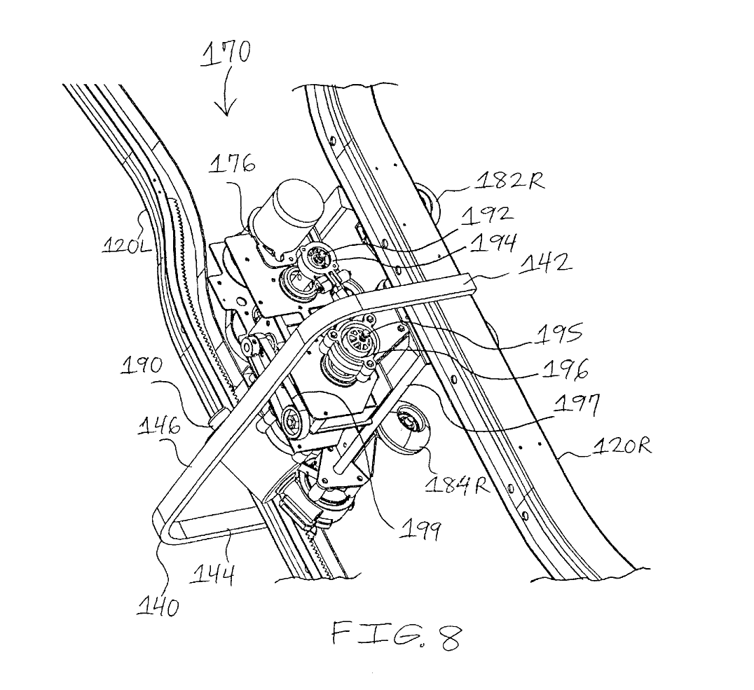

Referring to FIGS. 1-9, the present invention is directed to a massage apparatus 100 for a massage chair wherein massage benefits or effects are provided to a back body area, a bottom body area, and a thigh body area of a user (not shown). Massage benefits or effects may also be provided to a head and neck body area of the user. The massage apparatus 100 includes a frame 110 and a massage device 170. Also, the present invention is directed to a massage chair 200 that includes a massage apparatus and at least one health monitoring device 210. The massage apparatus of massage chair 200 is preferably massage apparatus 100.

As one aspect of the present invention, a non-limiting example, and best shown in FIGS. 1-3, the frame 110 of the massage apparatus 100 includes a pair of opposing guide rails 120R,120L, a plurality of guide rails stabilizing bars 140, and a base stand 150. The guide rails 120R,120L are secured to the base stand 150, and are positioned generally above the base stand 150. The base stand 150 supports the weights of the guide rails 120R,120L, massage device 170, and user (not shown) of the massage chair.

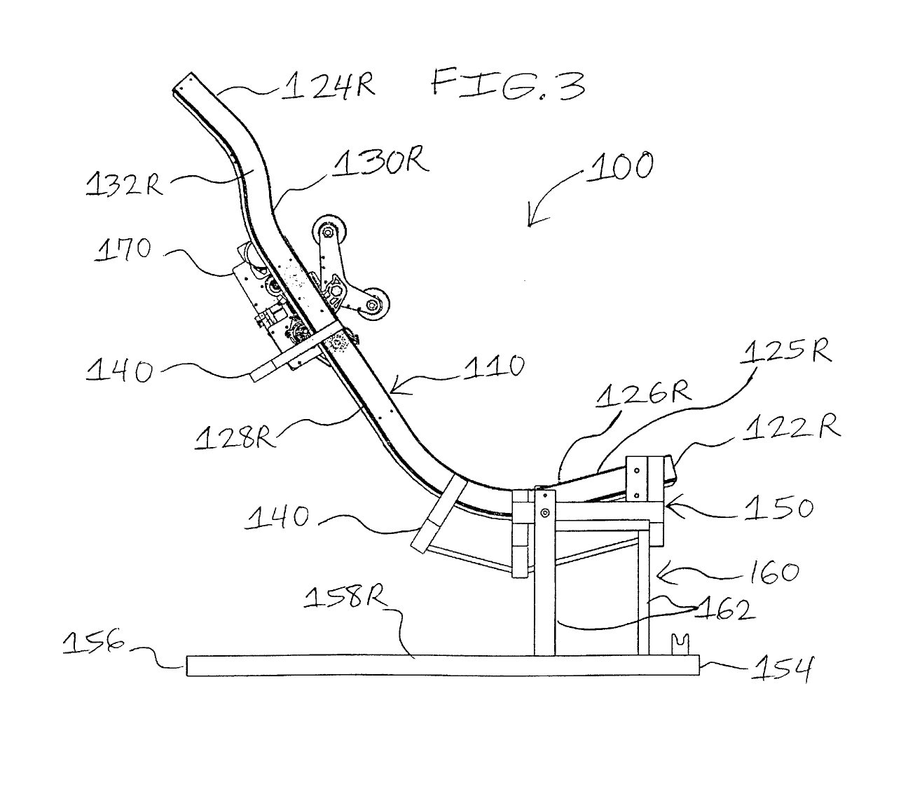

Preferably, the guide rails 120R,120L are substantially similar or mirror images of one another. Each of the guide rails 120R,120L includes a first end 122R,122L, a second end 124R,124L, a thigh body area portion 125R,125L located adjacent the first end 122R,122L, a seat or bottom body area portion 126R,126L located adjacent the thigh body area portion 125R,125L and away from the first end 122R,122L, a back body area portion 128R,128L extending upward from the bottom body area portion 126R,126L, a head and neck body area portion 130R,130L extending upward from the back body area portion 128R,128L and located about the second end 124R,124L, an outer side 132R,132L, an inner side 134, and a guide channel 136 extending from the thigh body area portion 125R,125L to the back body area portion 128R,128L, preferably to the head and neck body area portion 130R,130L, and running along the inner side 134 of the guide rail 120R,120L. The guide channel 136 includes gear teeth 138 for engaging with at least one gear member from the massage device 170 when the massage device 170 moves upward and downward in a generally vertical direction from the first end 122R,122L toward the second end 124R,124L of the guide rail 120R,120L and vice versa, respectively. Preferably, each of the guide rails 120R,120L has a generally “L-shaped” configuration. In this configuration, the lower portion of the “L” includes the thigh body area portion 125R,125L and bottom body area portion 126R,126L, and the upper portion of the “L” includes the back body area portion 128R,128L and head and neck body area portion 130R,130L. As best shown in FIGS. 1 and 3, more preferably, each of the guide rails 120R,120L has a reclining “L-shaped” configuration.

The plurality of guide rails stabilizing bars 140 help to stabilize the positioning of the guide rails 120R,120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R,132L of the guide rails 120R,120L.

The base stand 150 includes a base 152 and a guide rails support structure 160. The base 152 includes a first or front end 154, a second or rear end 156, and a pair of opposing sides 158R,158L. The guide rails support structure 160 is secured about the front end 154 of the base 152, and is positioned above the base 152. The guide rails support structure 160 includes a plurality of vertical bars or members 162 and a plurality of horizontal bars or members 164. The plurality of vertical bars 162 extend upward from the pair of opposing sides 158R,158L of the base 152, and, along with the plurality of horizontal bars 164, form a support frame with a “square-shaped” or “rectangular-shaped” box configuration.

Since the base stand 150 supports the weights of the guide rails 120R,120L, massage device 170, and user of the massage chair, the base stand 150 is preferably made or manufactured of a strong material, such as, but not limited to, steel, metal, wood, hard plastic, any combination of the listed materials, and any material or combination of materials known to one of ordinary skill in the art. Also, the guide rails 120R,120L may be made or manufactured of steel, metal, wood, plastic, any combination of the listed materials, and any material or combination of materials known to one of ordinary skill in the art.

The massage device 170 includes a power source, at least one massage element, and at least one gear member. The massage device 170 may be a conventional massage device or any applicable massage device that is known to one of ordinary skill in the art.

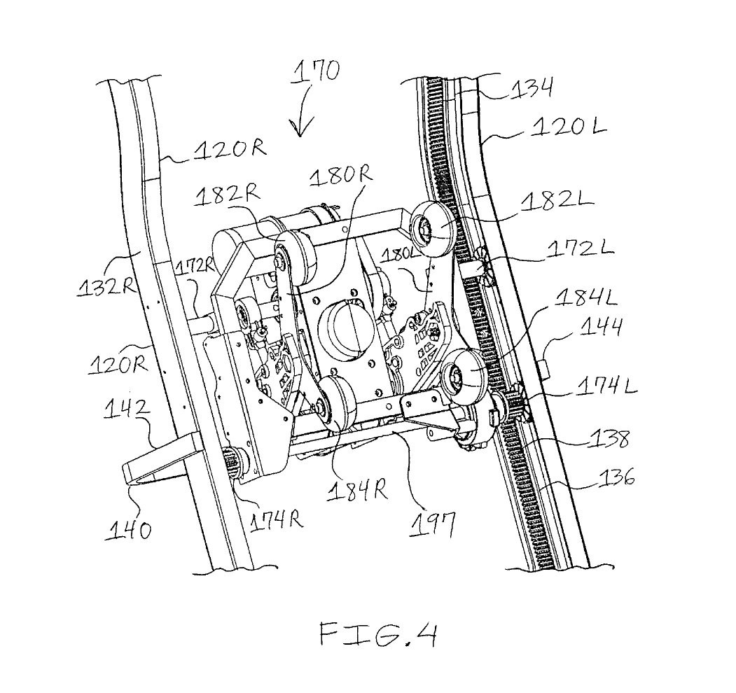

As a non-limiting example and as best shown in FIGS. 4-8, the massage device 170 includes a pair of massage device moving members 172R,172L, a pair of gear members 174R,174L, a pair of massage arms 180R,180L, a first motor 176, a second motor 178, a third motor 190, a rotation shaft 192 driven by the first motor 176, a pair of rotation to knocking translator members 194, a rotation shaft 195 driven by the second motor 178, a pair of rotation to kneading translator members 196, a rotation shaft 197 for vertical movement gears driving, a speed reduction belt 198 for the first motor 176, and a speed reduction belt 199 for the second motor 178.

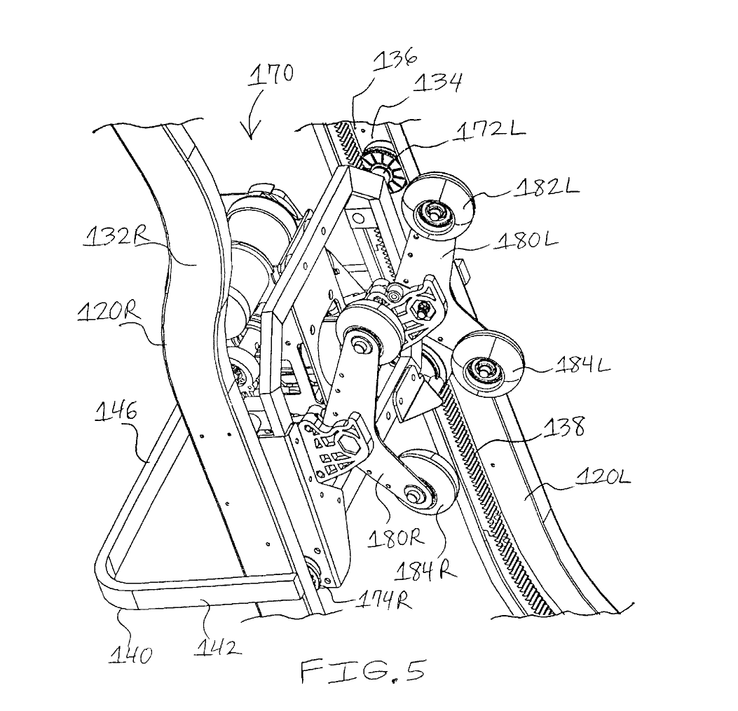

As best shown in FIGS. 4 and 5, each of the pair of massage device moving members 172R,172L is positioned within a corresponding guide channel 136 of a guide rail 120R,120L, and helps the massage device 170 move in a generally vertical direction along the guide channel 136.

As best shown in FIGS. 4 and 5, each of the pair of gear members 174R,174L is positioned within a corresponding guide channel 136 of a guide rail 120R,120L, and engages with the teeth 138 located in the corresponding guide channel 136.

As best shown in FIGS. 4-8, each of the pair of massage arms 180R,180L includes a first or upper massage roller 182R,182L and a second or lower massage roller 184R,184L. Each of the pair of massage arms 180R,180L can move vertically. As a non-limiting example, each of the pair of massage arms 180R,180L may be able to move both vertically and laterally. The massage rollers 182R,182L,184R,184L provide massage benefits or effects to a back body area, a bottom body area, and a thigh body area of the user when the massage device 170 is moved to, near or about that particular body area. The massage rollers 182R,182L,184R,184L may also provide massage benefits or effects to a head and neck area of the user when the massage device 170 is moved to, near or about the head and neck area. It will be understood by one of ordinary skill in the art that the timing of the pattern of the raising and lowering may be varied on each roller 182R,182L,184R,184L, such as by adjusting the degree of rotation of one or more of the following: rotation shaft 192 driven by the first motor 176, pair of rotation to knocking translator members 194, rotation shaft 195 driven by the second motor 178, pair of rotation to kneading translator members 196, speed reduction belt 198 for the first motor 176, and speed reduction belt 199 for the second motor 178. Also, it will be understood by one of ordinary skill in the art that the rate of speed of rotation as well as the direction of rotation of the rollers 182R,182L,184R,184L may be adjusted by varying the motor speed or direction.

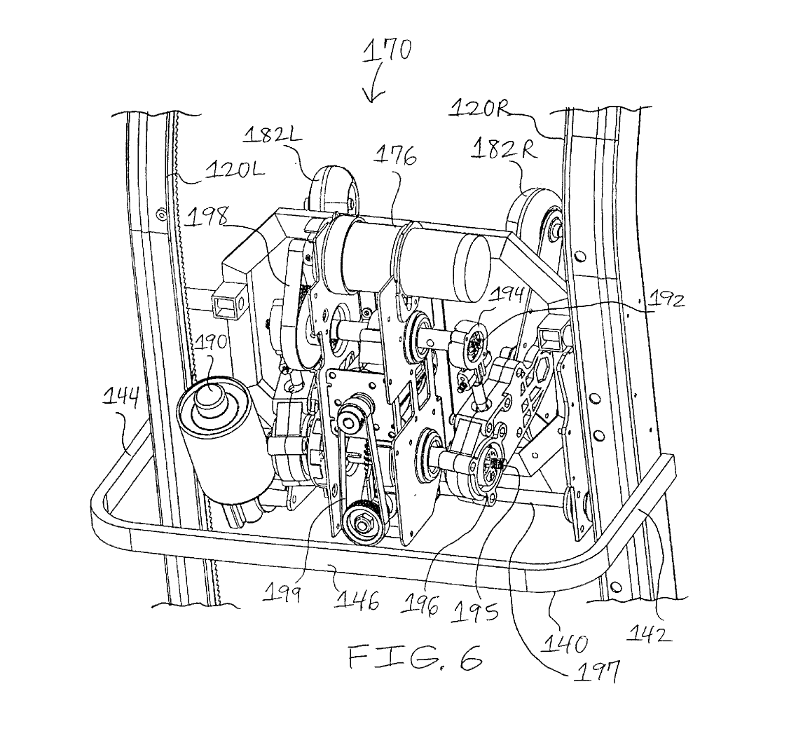

As best shown in FIGS. 6-8, the first and second motors 176,178 provide power to the pair of massage arms 180R,180L, respectively, while the third motor 190 provides power for the generally vertical movement of the massage device 170.

As best shown in FIGS. 6-8, the rotation shaft 192 driven by the first motor 176 causes the first massage arm 180R to be activated and to carry out its massage actions when this rotation shaft 192 is rotated.

As best shown in FIGS. 6-8, each of the pair of rotation to knocking translator members 194 assists the corresponding massage arm 180R,180L and corresponding massage roller(s) 182R,182L,184R,184L to carry out its knocking massage actions when the corresponding rotation shaft 192,195 is rotated.

As best shown in FIGS. 6-8, the rotation shaft 195 driven by the second motor 178 causes the second massage arm 180L to be activated and to carry out its massage actions when this rotation shaft 195 is rotated.

As best shown in FIGS. 6-8, each of the pair of rotation to kneading translator members 196 assists the corresponding massage arm 180R,180L and corresponding massage roller(s) 182R,182L,184R,184L to carry out its kneading massage actions when the corresponding rotation shaft 192,195 is rotated.

As best shown in FIGS. 6-8, the rotation shaft 197 for vertical movement gears driving causes the massage device 170 to move upward or downward when this rotation shaft 197 is rotated.

As best shown in FIG. 6, the speed reduction belt 198 for the first motor 176 adjusts the speed of the first massage arm 180R.

As best shown in FIGS. 6-8, the speed reduction belt 199 for the second motor 178 adjusts the speed of the second massage arm 180L.

When in use or in operation, the user (not shown) may activate the massage device 170 of the massage apparatus 100 for a massage chair by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the generally vertical movement of the massage device 170 and massage rollers 182R,182L,184R,184L upward and downward along the guide rails 120R,120L such that the massage device 170 and massage rollers 182R,182L,184R,184L are positioned about, near or at a desired body part area, such as the thighs, bottom, lower back, upper back, and head and neck, of the user so that desired body part area of the user can receive massage effects or benefits from the massage rollers 182R,182L,184R,184L when desired. Preferably, the user is also able to control the timing, movement, etc. of the massage rollers 182R,182L,184R,184L such that that the massage rollers 182R,182L,184R,184L can provide different massage effects or benefits, such as knocking, keading, etc., to the desired body part area of the user at a particular moment or time.

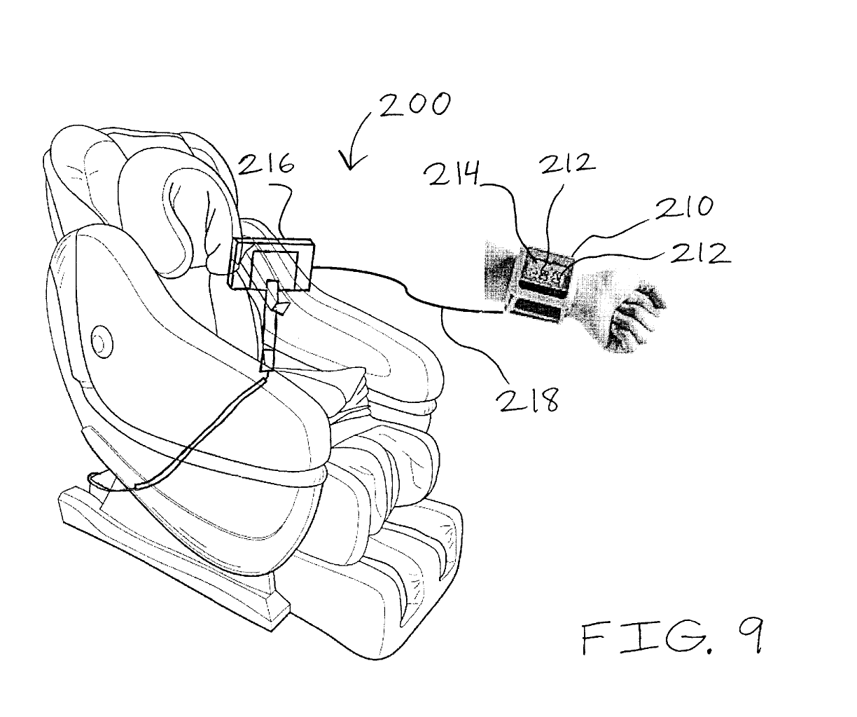

Referring to FIG. 9 and as another aspect of the present invention, the massage chair 200 includes a massage apparatus and at least one health monitoring device or system 210. The massage apparatus is preferably massage apparatus 100, described above, that includes the frame 110 and massage device 170, or is a massage apparatus that is substantially similar to massage apparatus 100.

As a non-limiting example shown in FIG. 9, the at least one health monitoring device or system 210 is a portable, wrist blood pressure and heart rate monitoring device 210 that is manufactured and/or programmed to measure or obtain the blood pressure and heart rate of the user right at or near the massage chair 200 when the user is preferably positioned on the massage chair 200. The blood pressure and heart rate monitoring device 210 is compact, convenient, and does not interfere with the massage functions of the massage chair 200. The blood pressure and heart rate monitoring device 210 provides blood pressure and heart rate measurements, and alerts the user and/or other persons, such as, but not limited to, an individual who is monitoring the user's blood pressure and heart rate. The measurement data 212 that is obtained from the user is displayed either on the device screen 214 or on a remote control 216 of the massage chair 200. The blood pressure and heart rate monitoring device 210 can be quickly connected to or disconnected from the massage chair 200 via a connector or cord 218, such as, but not limited to, a detachable DC power supply cord.

As an alternative to the blood pressure and heart rate monitoring device 210 of this embodiment, the at least one health monitoring device 210 may be a blood pressure monitoring or measuring device and a heart rate monitoring or measuring device that are separate from one another, or just either of those devices. As another alternative to the blood pressure and heart rate monitoring device 210 of this embodiment, the at least one health monitoring device 210 may encompass any individual or combinations of health monitoring functions, such as, but not limited to, blood pressure monitoring and/or measuring, heart rate monitoring or measuring, cholesterol monitoring or measuring, fat monitoring or measuring, and blood sugar monitoring or measuring. Alternatively, the at least one health monitoring device 210 may be or include any health monitoring device(s) that is/are known to one of ordinary skill in the art.

It is to be understood that the present invention is not limited to the embodiments described above or as shown in the attached figures, but encompasses any and all embodiments within the spirit of the invention.

What is claimed is:

1. A massage chair comprising:
a massage apparatus that comprises a frame and a massage device,
wherein said frame comprises at least one guide rail,
wherein each of said at least one guide rail comprises a first end, a second end, a thigh body area portion located about said first end, a bottom body area portion located proximate said thigh body area portion and away from said first end, and a back body area portion extending upward from said bottom body area portion,
wherein said massage device comprises a power source and at least one massage element,
wherein said massage device is secured to said at least one guide rail, and
wherein said power source provides power to said massage device wherein said at least one massage element is moved with respect to said at least one guide rail whereby said at least one massage element is able to provide massage effects to a thigh body area, a bottom body area, and a back body area of a user.

2. The massage chair according to claim 1, further comprising at least one guide rails stabilizing bar to stabilize the positioning of said at least one guide rail relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein said at least one guide rail is a pair of opposing guide rails, wherein each of said guide rails further comprises a head and neck body area portion extending upward from said back body area portion and located about said second end, an outer side, an inner side, and a guide channel extending from said thigh body area portion to said head and neck body area portion, wherein said guide channel runs along said inner side, and wherein said guide channel comprises gear teeth for engaging with at least one gear member of said massage device when said massage device moves from said first end of said guide rail toward said second end of said guide rail and vice versa, respectively.

3. The massage chair according to claim 1, wherein said each of said at least one guide rail further comprises a head and neck body area portion extending upward from said back body area portion and located about said second end.

4. The massage chair according to claim 1, wherein each of said at least one guide rail has a generally “L-shaped” configuration, and wherein said at least one massage element is moved in a generally vertical direction upward and downward along said at least one guide rail.

5. The massage chair according to claim 1, wherein said frame further comprises a base stand, wherein said at least one guide rail is secured to said base stand and is positioned generally above said base stand, wherein said base stand supports weights of said at least one guide rail, said massage device, and a user of said massage chair, wherein said base stand comprises a base and a guide rails support structure, and wherein said guide rails support structure is secured about said base and is positioned above said base.

6. The massage chair according to claim 1, wherein each of said at least one guide rail further comprises a guide channel extending from said thigh body area portion to said back body area portion.

7. The massage chair according to claim 6, further comprising at least one guide rails stabilizing bar to stabilize the positioning of said at least one guide rail relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein said at least one guide rail is a pair of opposing guide rails, wherein each of said guide rails further comprises a head and neck body area portion extending upward from said back body area portion and located about said second end, an outer side, and an inner side, wherein said guide channel extends from said thigh body area portion to said head and neck body area portion, wherein said guide channel runs along said inner side, wherein said guide channel comprises gear teeth, wherein said massage device further comprises at least one gear member, and wherein said gear teeth of said guide channel engages with said at least one gear member of said massage device when said massage device moves from said first end of said guide rail toward said second end of said guide rail and vice versa, respectively.

8. The massage chair according to claim 6, wherein each of said at least one guide rail has a generally “L-shaped” configuration, wherein said at least one massage element is moved in a generally vertical direction upward and downward along said at least one guide rail, wherein said frame further comprises a base stand, wherein said at least one guide rail is secured to said base stand and is positioned generally above said base stand, wherein said base stand supports weights of said at least one guide rail, said massage device, and a user of said massage chair, and wherein said base stand comprises a base and a guide rails support structure, and wherein said guide rails support structure is secured about said base and is positioned above said base.

9. The massage chair according to claim 1,
wherein said frame comprises a pair of opposing guide rails,
wherein each of said guide rails further comprises an outer side, an inner side, and a guide channel extending from said thigh body area portion to said back body area portion,
wherein said guide channel runs along said inner side,
wherein said guide channel comprises gear teeth,
wherein said massage device further comprises at least one gear member,
wherein said massage device is secured to said guide rails, and
wherein said at least one gear member engages with said gear teeth of said guide channel when said massage device moves from said first end of said guide rail toward said second end of said guide rail and vice versa, respectively.

10. The massage chair according to claim 9, further comprising at least one guide rails stabilizing bar to stabilize the positioning of said guide rails relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein each of said guide rails further comprises a head and neck body area portion extending upward from said back body area portion and located about said second end, and wherein said guide channel extends from said thigh body area portion to said head and neck body area portion.

11. The massage chair according to claim 9, wherein each of said at least one guide rail has a generally “L-shaped” configuration, wherein said at least one massage element is moved in a generally vertical direction upward and downward along said guide rails, wherein said frame further comprises a base stand, wherein said guide rails are secured to said base stand and are positioned generally above said base stand, wherein said base stand supports weights of said guide rails, said massage device, and a user of said massage chair, wherein said base stand comprises a base and a guide rails support structure, and wherein said guide rails support structure is secured about said base and is positioned above said base.

12. A massage chair comprising:
a massage apparatus comprising a frame and a massage device,
wherein said massage device is secured to and in operative communication with said frame,
wherein said massage device comprises a power source and at least one massage element,
wherein said power source provides power to said massage device wherein said at least one massage element is moved with respect to said frame whereby said at least one massage element is able to provide massage effects to at least one body area of a user; and
at least one health monitoring device performing at least one health monitoring function for the user.

13. The massage chair according to claim 12, wherein said at least one health monitoring device is a portable, health monitoring device that performs at least one monitoring function selected from the group consisting of blood pressure monitoring, heart rate monitoring, cholesterol monitoring, fat monitoring, blood sugar monitoring, and any combination thereof.

14. The massage chair according to claim 12,
wherein said frame comprises at least one guide rail,
wherein each of said at least one guide rail comprises a first end, a second end, a thigh body area portion located about said first end, a bottom body area portion located proximate said thigh body area portion and away from said first end, and a back body area portion extending upward from said bottom body area portion,
wherein said massage device is secured to said at least one guide rail, and
wherein said at least one massage element is moved with respect to said at least one guide rail whereby said at least one massage element is able to provide massage effects to a thigh body area, a bottom body area, and a back body area of the user.

15. The massage chair according to claim 14, further comprising at least one guide rails stabilizing bar to stabilize the positioning of said at least one guide rail relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein said at least one guide rail is a pair of opposing guide rails, wherein each of said guide rails further comprises a head and neck body area portion extending upward from said back body area portion and located about said second end, an outer side, an inner side, and a guide channel extending from said thigh body area portion to said head and neck body area portion, wherein said guide channel runs along said inner side, and wherein said guide channel comprises gear teeth for engaging with at least one gear member of said massage device when said massage device moves from said first end of said guide rail toward said second end of said guide rail and vice versa, respectively.

16. The massage chair according to claim 14, wherein said each of said at least one guide rail further comprises a head and neck body area portion extending upward from said back body area portion and located about said second end, wherein each of said at least one guide rail has a generally “L-shaped” configuration, and wherein said at least one massage element is moved in a generally vertical direction upward and downward along said at least one guide rail.

17. The massage chair according to claim 14, wherein said frame further comprises a base stand, wherein said at least one guide rail is secured to said base stand and is positioned generally above said base stand, wherein said base stand supports weights of said at least one guide rail, said massage device, and a user of said massage chair, wherein said base stand comprises a base and a guide rails support structure, and wherein said guide rails support structure is secured about said base and is positioned above said base.

18. The massage chair according to claim 14, wherein said at least one health monitoring device is a portable, health monitoring device that performs at least one monitoring function selected from the group consisting of blood pressure monitoring, heart rate monitoring, cholesterol monitoring, fat monitoring, blood sugar monitoring, and any combination thereof.

19. The massage chair according to claim 14, wherein each of said at least one guide rail further comprises a guide channel extending from said thigh body area portion to said back body area portion.

20. The massage chair according to claim 19, further comprising at least one guide rails stabilizing bar to stabilize the positioning of said at least one guide rail relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein said at least one guide rail is a pair of opposing guide rails, wherein each of said guide rails further comprises a head and neck body area portion extending upward from said back body area portion and located about said second end, an outer side, and an inner side, wherein said guide channel extends from said thigh body area portion to said head and neck body area portion, wherein said guide channel runs along said inner side, wherein said guide channel comprises gear teeth, wherein said massage device further comprises at least one gear member, and wherein said gear teeth of said guide channel engages with said at least one gear member of said massage device when said massage device moves from said first end of said guide rail toward said second end of said guide rail and vice versa, respectively.

21. The massage chair according to claim 19, wherein each of said at least one guide rail has a generally “L-shaped” configuration, wherein said at least one massage element is moved in a generally vertical direction upward and downward along said at least one guide rail, wherein said frame further comprises a base stand, wherein said at least one guide rail is secured to said base stand and is positioned generally above said base stand, wherein said base stand supports weights of said at least one guide rail, said massage device, and a user of said massage chair, and wherein said base stand comprises a base and a guide rails support structure, and wherein said guide rails support structure is secured about said base and is positioned above said base.

22. The massage chair according to claim 19, wherein said at least one health monitoring device is a a portable, health monitoring device that performs at least one monitoring function selected from the group consisting of blood pressure monitoring, heart rate monitoring, cholesterol monitoring, fat monitoring, blood sugar monitoring, and any combination thereof.

23. The massage chair according to claim 14,
wherein said frame comprises a pair of opposing guide rails,
wherein each of said guide rails further comprises an outer side, an inner side, and a guide channel extending from said thigh body area portion to said back body area portion,
wherein said guide channel runs along said inner side,
wherein said guide channel comprises gear teeth,
wherein said massage device further comprises at least one gear member,
wherein said massage device is secured to said guide rails, and
wherein said at least one gear member engages with said gear teeth of said guide channel when said massage device moves from said first end of said guide rail toward said second end of said guide rail and vice versa, respectively.

24. The massage chair according to claim 23, further comprising at least one guide rails stabilizing bar to stabilize the positioning of said guide rails relative to one another, wherein each of said guide rails stabilizing bar comprises a first end, a second end, and a body portion extending from said first end to said second end of said guide rails stabilizing bar, wherein said guide rails stabilizing bar is secured at a predetermined location of each of said guide rails, wherein each of said guide rails further comprises a head and neck body area portion extending upward from said back body area portion and located about said second end, and wherein said guide channel extends from said thigh body area portion to said head and neck body area portion.

25. The massage chair according to claim 23, wherein each of said at least one guide rail has a generally “L-shaped” configuration, and wherein said at least one massage element is moved in a generally vertical direction upward and downward along said guide rails.

26. The massage chair according to claim 23, wherein said frame further comprises a base stand, wherein said guide rails are secured to said base stand and are positioned generally above said base stand, wherein said base stand supports weights of said guide rails, said massage device, and a user of said massage chair, wherein said base stand comprises a base and a guide rails support structure, and wherein said guide rails support structure is secured about said base and is positioned above said base.

27. The massage chair according to claim 23, wherein said at least one health monitoring device is a a portable, health monitoring device that performs at least one monitoring function selected from the group consisting of blood pressure monitoring, heart rate monitoring, cholesterol monitoring, fat monitoring, blood sugar monitoring, and any combination thereof.
